(19) United States
(12) Patent Application Publication
(10) Pub. No.: US 2026/0094536 A1
(43) Pub. Date: Apr. 2, 2026

(54) WORKSTATIONS FOR THE VISUALLY IMPAIRED

(71) Applicant: TEXAS STATE UNIVERSITY, San Marcos, TX (US)

(72) Inventors: Abhimanyu Sharotry, San Marcos, TX (US); Noe Tavira, Austin, TX (US); Jesus Jimenez, New Braunfels, TX (US); Francis A. Mendez Mediavilla, San Marcos, TX (US)

(73) Assignee: TEXAS STATE UNIVERSITY, San Marcos, TX (US)

(21) Appl. No.: 19/285,722

(22) Filed: Jul. 30, 2025

Related U.S. Application Data
(60) Provisional application No. 63/700,662, filed on Sep. 28, 2024.

(51) Int. Cl. G09B 21/00

(52) U.S. Cl. CPC G09B 21/001

(57) ABSTRACT

Systems operable for monitoring a user’s operations are disclosed. The system includes a workstation and a sensor operable to obtain data from the workstation. The data is related to the user’s operation of the workstation. The system further includes a computer system in electronic communication with the sensor. The computer system is operable to receive the data from the sensor, process the data, and provide feedback to the user related to the user’s operation of the system. Methods of monitoring a user’s operation of a system are also disclosed. The method includes utilizing a sensor to obtain data and feeding the data to a computer system. The computer system processes the data and provides feedback to the user related to the user’s operation of the system.

### CROSS-REFERENCE TO RELATED APPLICATIONS

This patent application claims priority from, and incorporates by reference the entire disclosure of, U.S. Provisional Patent Application 63/700,662 filed on September 28, 2024.

### TECHNICAL FIELD

The present disclosure relates generally to workstations and more particularly, but not by way of limitation, to workstations for the impaired.

### BACKGROUND

This section provides background information to facilitate a better understanding of the various aspects of the disclosure. The statements in this section of this document are to be read in this light, and not as admissions of prior art.

People with impairments (e.g., visual impairments) face significant challenges when using conventional workstations and machinery in industrial settings. The lack of tactile, visual, or auditory feedback in many systems can lead to errors or safety risks, particularly when handling complex or hazardous equipment. These barriers not only compromise operational efficiency but also hinder the full participation of individuals with impairments in industrial environments.

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

In a particular embodiment, the present disclosure relates to a system operable for monitoring a user’s operation. In some embodiments, the system includes a workstation and a sensor operable to obtain data from the workstation. In some embodiments, the data is related to the user’s operation of the workstation. In certain embodiments, the system further includes a computer system in electronic communication with the sensor. In some embodiments, the computer system is operable to receive the data from the sensor, process the data, and provide feedback to the user related to the user’s operation of the system.

In another embodiment, the present disclosure pertains to a method of monitoring a user’s operation of a system. In some embodiments, the system includes a workstation, a sensor, and a computer system in electronic communication with the sensor. In certain embodiments, the method includes utilizing the sensor to obtain data from the workstation. In some embodiments, the data is related to the user’s operation of the workstation. In certain embodiments, the method further includes feeding the data to the computer system. In some embodiments, the computer system processes the data and provides feedback to the user related to the user’s operation of the system.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIG. 1 illustrates an example system operable for monitoring a user’s operation.

FIG. 2 illustrates an example method of monitoring a user’s operation of a system, for example, the system of FIG. 1.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described.

In the realm of industrial process optimization, the concept of a human digital twin tailored for disabled workers remains underdeveloped. Existing human digital twin frameworks simulate worker interactions and states, but do not adequately incorporate the specialized skills and support requirements of disabled individuals. This oversight necessitates the modification and enhancement of human digital twin methodologies to integrate disabled workers effectively.

In some embodiments, the systems and methods of the present disclosure address these research gaps, emphasizing the need for real-time data acquisition, smart device integration, and personalized worker feedback. The systems and methods of the present disclosure harness sophisticated computer sensing algorithms to scrutinize workstations, a technology already prevalent in industrial applications for quality control, efficiency tracking, and operational analysis.

Despite its widespread use, the adaptation of computer sensing technology to support disabled workers is still nascent. Recognizing the diverse spectrum of disabilities and the necessity for customized industrial solutions, recent studies have ventured into the application of computer sensing for disability assistance. Innovations include a computer sensing-assisted system for the visually impaired, utilizing edge artificial intelligence and depth sensors for enhanced perception, and a facial gesture recognition system for hands-free mouse control, aiding those with motor impairments. However, a needs exists for integrating these advances into workstations for users with impairments.

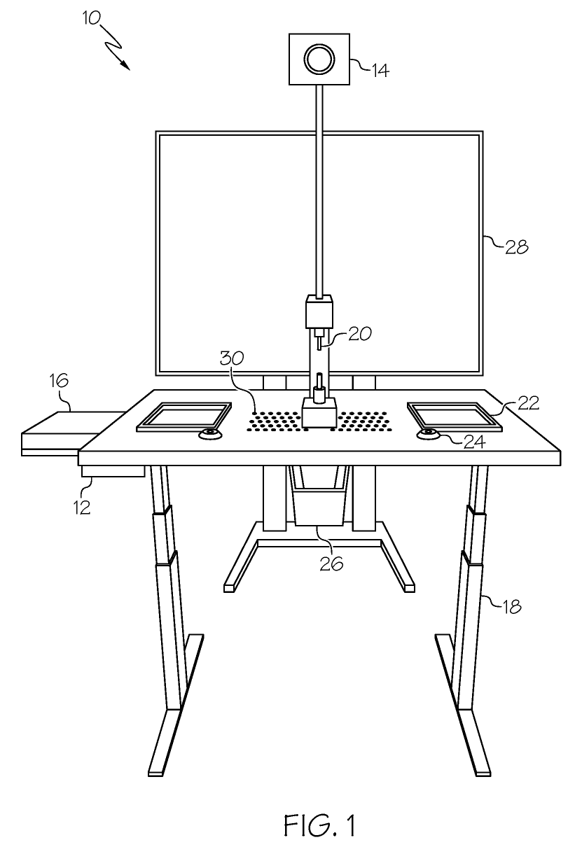

As such, in some embodiments, the present disclosure pertains to a system operable for monitoring a user’s operation. An exemplary system of the present disclosure is illustrated as system 10 in FIG. 1. The system 10 generally includes a workstation 12 and a sensor 14 operable to obtain data from the workstation 12. In some embodiments, the data is related to the user’s operation of the workstation 12. In certain embodiments of FIG. 1, the system 10 may be a switch system specifically designed to accommodate operators with impairments in industrial settings. In some embodiments, the system 10 incorporates a computer sensing system, utilizing the sensor 14, with the existing switch setup on a machine, for example a manual punching system 20, used for punching or pressing tasks. In some embodiments, the workstation 12 further includes a design for totes 22.

The methods and systems of the present disclosure may utilize various sensors. For instance, in some embodiments, the sensor may include a multi-modal sensor engine that includes one or more sensing modalities. In some embodiments, the sensor may include any combination of optical sensors (e.g., three-dimensional and/or two-dimensional cameras, LiDAR, thermal infrared systems, and/or optical motion capture systems); electromagnetic sensors (e.g., mm Wave radar, UWB radar, Wi-Fi-based sensing, RFID phase tracking, and/or magnetic field tomography); acoustic or mechanical sensors (e.g., ultrasonic arrays and/or acoustic sensor arrays); biometric sensors (e.g., EMG and/or capacitive touch sensors); network-based sensors (e.g., RF tomographic mesh networks); or combinations thereof. In some embodiments, the sensor may include a visual sensor, such as a camera. In some embodiments, the systems and methods of the present disclosure may employ sensor fusion algorithms to combine data from multiple sensing modalities for enhanced accuracy and robustness.

The methods and systems of the present disclosure may obtain various data from sensors. For instance, in some embodiments, the data may include visual data. In some embodiments, the data may include thermal imaging data.

In some embodiments, the sensor 14 may include thermal sensor feed integration. In some embodiments, the sensor 14 may include thermal camera video feed integration. In some embodiments, the sensor 14 may include thermal imaging sensors. In some embodiments, thermal sensor feed integration-compatible thermal imaging sensors may detect and assist in differentiating operator presence and limb positioning based on heat signatures of the user. Additionally, in certain embodiments, the thermal imaging sensors may provide a redundant input for safety verification, ensuring no operator limb is within danger zones during equipment activation. In some embodiments, the thermal sensors may provide a redundant sensor input to help eliminate occlusions in human-pose estimation that sometimes result with regular non-thermal-imaging capable sensors. In certain embodiments, the system 10 includes a computer system 16 in electronic communication with the sensor 14. In some embodiments, the computer system 16 is operable to receive data from the sensor 14, process the data, and provide feedback (e.g., tactile, visual, or auditory) to the user related to the user’s operation of the system 10. In some embodiments, the computer system 16 may include, for example, algorithms (e.g., computer sensing and/or computer vision algorithms) and/or software operable to receive and process the data from the sensor 14 in real-time.

FIG. 1 illustrates enhancements that involve the addition of the sensor 14 over the workstation 12, which monitors the operator’s hands. In some embodiments, the sensor 14 sends sensor data to the computer system 16 that uses computer sensing algorithms, machine learning models, or other artificial intelligence, via software, for example, to analyze the footage in real-time. In this manner, the system 10 may confirm the operator’s hands are on buttons 24. Moreover, in some embodiments, the buttons 24 may also be in electronic communication with the computer system 16.

In some embodiments, the buttons 24 may include, for example, general-purpose input/output physical buttons, inductive proximity sensors, capacitive touch and/or touchless sensors, time-of-flight sensors configured as “touch” proxies, and combinations of the same and like. In some embodiments, general-purpose input/out physical buttons may provide fast response and timestamp-logging capability, while inductive proximity sensors (e.g., contactless) may be used to detect operator hand presence near a designated interface of the workstation 12. Additionally, in certain embodiments, inductive proximity sensors may assist in reducing false positives caused by faulty mechanical button-based inputs and provide smoother press-activation profiles. In some embodiments, capacitive field sensors may be used for close-range presence detection, while touchless capacitive sensors may be used to register hand gestures or approach within a defined region of the workspace 12. In some embodiments, time-of-flight sensors configured as “touch” proxies may be repurposed to function as virtual touch sensors. In such embodiments, when an object (e.g., a hand) is detected at a calibrated proximity, time-of-flight sensor configuration may allow for the system to have a secondary input (i.e., a validation step) for a press activation event.

In some embodiments, the system 10 may allow operation when the system 10 verifies the operator’s hands are correctly placed on the buttons 24, and/or the buttons 24 are being pressed, reinforcing standard industry safety protocols. Additionally, the system 10 may provide tactile, visual, or auditory feedback related to operation of the system 10. In some embodiments, these features are particularly beneficial for operators with impairments (e.g., visual impairments) as it ensures their safety while operating machinery within the system 10. Moreover, in some embodiments, the system 10 can detect when an unauthorized object is used to press the buttons 24. In certain embodiments, this may add an extra layer of security, ensuring the system 10 operates under strict safety conditions, and prevents any misuse that could lead to dangerous situations or operational errors.

In some embodiments, the computer system 16 may also include databases or datasets, and/or a data export function, allowing for the extraction of various metrics, such as timestamps, sensor data, the number of correct operations, and combinations of the same and like. In some embodiments, this allows for maintaining records, analysis, and improving operational efficiency by providing valuable insights into the usage of the system 10 and adherence to safety protocols.

In certain embodiments, the computer system 16 may be one or more local or remote computer systems 16. In some embodiments, the computer system 16 may implement modularity and micro-controller system integration. For example, in some embodiments, computer system 16 may utilize a micro-controller offload architecture such that general-purpose input/output and/or sensor event captures are offloaded to a micro-controller, reducing latency and computer processor load on while additionally enabling system modularity of the computer system 16.

In some embodiments, the computer system 16 may include machine-voice commands for activation and/or actuation. In some embodiments, enabling voice-command operation of the system 10 offers a natural, accessible, hands-free method for impaired (e.g., visually impaired) operators to control the workstation 12. For example, in certain embodiments, a close-range microphone or wearable wireless microphone may capture voice commands. In some embodiments, the microphone may be positioned to reduce ambient noise, or for example, use directional or noise-canceling technology. In some embodiments, the system 10 may use local, remote, or hybrid local/remote voice recognition systems. In some embodiments, the voice recognition systems mat provide support for multiple languages.

In certain embodiments, the computer system 16 may utilize integration of wearable electroencephalogram electronics into a brain–artificial intelligence closed-loop system to offer an advanced, hands-free, and cognitively driven control mechanism to enable and/or assist activation of a machine within the system 10 using brain signals, reducing reliance on manual input and increasing accessibility and safety for impaired operators. For example, in certain embodiments, the brain–artificial intelligence closed-loop system may be a feedback-driven interface where the brain sends control intentions via electroencephalogram. In such embodiments, the computer system 16 may decode those intentions into actionable commands such as “operate now”. In some embodiments, the computer system 16 executes the action by activating the equipment on the workstation 12, and the operator receives sensory or system feedback, closing the loop.

In some embodiments, components of the brain–artificial intelligence closed-loop system may include, for example, a portable, non-invasive electroencephalogram headset that captures brainwave patterns. In such embodiments, electrodes record electrical activity in the motor cortex and/or frontal cortex, associated with attention, intention, or imagined movement. In some embodiments, electroencephalogram signals may be preprocessed through artifact removal and bandpass filtering. In some embodiments, commands are extracted from alpha/beta rhythms, event-related potentials, steady state visually evoked potential, and combinations of the same and like.

In certain embodiments, an artificial intelligence or machine learning model is trained to detect intentional recognition of predefined phrases like “start equipment”, “operate now”, “emergency stop”, or “status check”, and combinations of the same and like. In some embodiments, wake-word functionality such as “hey machine”, “system status”, or “operator ready” may be used to prevent accidental activation. In certain embodiments, when an activation intent is classified, the computer system 16 may send a trigger to the general-purpose input/output interface controlling the equipment relay circuitry. Additionally, in some embodiments, the trigger may be sent to a monitoring system for safety and system operational confirmation. In some embodiments, the monitoring system is incorporated into the computer system 16. In various embodiments, the monitoring systems may be one or more separate or remote computer systems 16.

In some embodiments, additional system feedback mechanisms and/or smart glasses may be used with the computer system 16. In some embodiments, audio/visual cues and/or haptic feedback such as visual, vibration, or audible beeps and/or chimes may confirm system status, for example, “system-ready” or “equipment activated”. In some embodiments, visual feedback may be provided via smart glasses or a screen for supervisors to view status and/or approve operation. In certain embodiments, audible verbal cues may be given via integration of a local and/or portable speaker system connected to the computer system 16.

In some embodiments, the workstation 12 may include a debris catchment and tactile feedback tabletop 30. In some embodiments, the workstation 12 further includes a height-adjustable base area 18. In some embodiments, the debris catchment and tactile feedback tabletop 30 and the height-adjustable base area 18 allows the workstation 12 to be equipped with worker-specific bin-picking locations while also being height-adjustable. In some embodiments, the workstation 12 may be self-adjusting as it detects a specific worker, based on, for example user schedules, audible commands, voice recognition, visual recognitions, and combinations of the same and like. In some embodiments, additional preferences for the system 10 and/or workstation 12 may also be applied when a specific worker is detected. In some embodiments, the location of the buttons 24 are adaptable to workers’ needs, thus personalizing the workstation 12 for each operator.

In certain embodiments, the debris produced from operation is collected in a waste dispenser 26 via the debris catchment and tactile feedback tabletop 30, thus maintaining a better working environment for the worker and providing the impaired operator with tactile feedback on the whereabouts of the equipment and buttons, which further enhances the safety and usability of the workstation for operators with impairments.

In some embodiments, the system 10 further includes a display screen 28. In some embodiments, the display screen 28 is in electrical communication with the sensor 14 and operable to display the operation of the workstation 12. In some embodiments, the display screen 28 may include warnings related to operation of the system 10, notifications related to specific tasks, or combinations of the same and like.

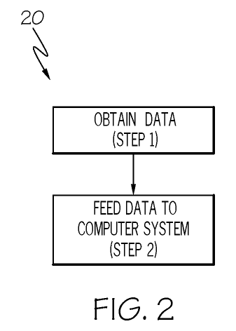

Additional embodiments, illustrated in FIG. 2, pertain to methods of monitoring a user’s operation of a system (e.g., the system 10) of the present disclosure. In some embodiments, method 20 of the present disclosure includes (Step 1) utilizing a sensor (e.g., the sensor 14) to obtain data from a workstation (e.g., the workstation 12). In some embodiments, the data is related to the user’s operation of the workstation. In certain embodiments, the method further includes (Step 2) feeding data to a computer system (e.g., the computer system 16). In some embodiments, the computer system processes the data from the sensor and provides feedback to the user related to the user’s operation of the system.

In some embodiments, the user is an impaired user. In some embodiments, the impaired user may have one or more impairments that include, without limitation, visual impairment, hearing impairment, speech impairment, mobility impairment, cognitive impairment, speech impairment, or combinations thereof. In some embodiments, the user may be a visually impaired user.

In some embodiments, the advantageous features of the systems and methods of the present disclosure include, without limitation: (1) a computer sensing (e.g., computer vision) integration, which incorporates an overhead sensor that monitors the operator’s hands, ensuring they are correctly placed on the machine buttons; (2) real-time analysis, which employs machine learning models to analyze sensor data in real-time, confirming safe operation; (3) safety protocol reinforcement, which operates when it verifies the correct hand placement and button press by the operator; (4) unauthorized use detection, which is capable of detecting and preventing the use of unauthorized objects to press the buttons, adding an extra layer of security; (5) data collection and export, which includes a database, for example, with a data export function for extracting metrics like timestamps, sensor data, and operation counts; (6) personalized workstations, which feature worker-specific bin picking locations and height-adjustable workstations that adapt to individual operator schedules and preferences; (7) adaptable button locations, which allows for customization of button locations based on worker preferences, thereby enhancing personalization; (8) waste reduction and tactile feedback, in which a catchment collects debris, reducing waste and providing tactile feedback to the operator.

In some embodiments, the methods and systems of the present disclosure incorporate adaptive interface customization capabilities, enabling real-time parameter adjustment for users with diverse accessibility needs, including hearing, mobility, cognitive, and speech impairments. In some embodiments, the machine learning architecture of the systems and methods of the present disclosure allow for personalized adaptation based on individual user requirements and interaction patterns.

These features collectively enhance the safety, efficiency, and accessibility of industrial workstations for operators with accessibility needs (e.g., users with vision, hearing, mobility, cognitive, and/or speech impairments), promoting inclusivity and personalization in the workplace. Such workstations of the present disclosure are more advantageous than existing workstations for the impaired. As such, the systems and methods of the present disclosure may be utilized in various settings, such as manufacturing facilities employing people with disabilities and/or impairments.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within (a percentage) of” what is specified, where the percentage includes 0.1, 1, 5, and 10 percent.

The foregoing outlines features of several embodiments so that those of ordinary skill in the art may better understand the aspects of the disclosure. Those of ordinary skill in the art should appreciate that they may readily use the disclosure as a basis for designing or modifying other processes and structures for carrying out the same purposes and/or achieving the same advantages of the embodiments introduced herein. Those of ordinary skill in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim is an open group. The terms “a”, “an”, and other singular terms are intended to include the plural forms thereof unless specifically excluded.

Conditional language used herein, such as, among others, “can”, “might”, “may”, “e.g.”, and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements, and/or states are in any way required for one or more embodiments.

While the above detailed description has shown, described, and pointed out novel features as applied to various embodiments, it will be understood that various omissions, substitutions, and changes in the form and details of the embodiments illustrated can be made without departing from the spirit of the disclosure. As will be recognized, the various embodiments described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

What is claimed is:

1. A system operable for monitoring a user’s operation, the system comprising:
a workstation;
a sensor operable to obtain data from the workstation, wherein the data is related to the user’s operation of the workstation; and
a computer system in electronic communication with the sensor, wherein the computer system is operable to:
receive the data from the sensor;
process the data; and
provide feedback to the user related to the user’s operation of the system.

2. The system of claim 1, wherein the workstation comprises a debris catchment and tactile feedback tabletop.

3. The system of claim 1, wherein the workstation further comprises a height-adjustable base.

4. The system of claim 1, wherein the workstation further comprises a manual punching system.

5. The system of claim 1, wherein the workstation further comprises a design for totes.

6. The system of claim 1, wherein the workstation further comprises buttons.

7. The system of claim 1, wherein the workstation further comprises a waste dispenser.

8. The system of claim 1, wherein the system further comprises a display screen in electrical communication with the sensor and operable to display the operation of the workstation by the user.

9. The system of claim 1, wherein the computer system comprises a machine learning algorithm operable to receive and process the data from the sensor in real-time.

10. The system of claim 1, wherein the user is an impaired user.

11. A method of monitoring a user’s operation of a system, wherein the system comprises:
a workstation, a sensor, and a computer system in electronic communication with the sensor; and
wherein the method comprises:
utilizing the sensor to obtain data from the workstation, wherein the data is related to the user’s operation of the workstation; and
feeding the data to the computer system, wherein the computer system processes the data and provides feedback to the user related to the user’s operation of the system.

12. The method of claim 11, wherein the workstation comprises a debris catchment and tactile feedback tabletop.

13. The method of claim 11, wherein the workstation further comprises a height-adjustable base.

14. The method of claim 11, wherein the workstation further comprises a manual punching system.

15. The method of claim 11, wherein the workstation further comprises a design for totes.

16. The method of claim 11, wherein the workstation further comprises buttons.

17. The method of claim 11, wherein the workstation further comprises a waste dispenser.

18. The method of claim 11, wherein the system further comprises a display screen in electrical communication with the sensor and operable to display the operation of the workstation by the user.

19. The method of claim 11, wherein the computer system processes the data via a machine learning algorithm.

20. The method of claim 11, wherein the user is an impaired user.
